(19) United States
(12) Patent Application Publication
(10) Pub. No.: US 2009/0094116 A1
(43) Pub. Date: Apr. 9, 2009

(54) METHOD FOR EXPEDITIOUS RESOURCE RE-ALLOCATION IN A NETWORK OF MEMBERS

(75) Inventors: Oladayo Olagunju, Palo Alto, CA (US); Wendong Zhu, Berwyn, PA (US)

Correspondence Address: Techtain Inc., 540 E. Charleston Rd., Palo Alto, CA, 94306, US

(73) Assignee: Techtain Inc., Palo Alto, CA (US)

(21) Appl. No.: 12/245,770

(22) Filed: Oct. 6, 2008

Related U.S. Application Data
(60) Provisional application No. 60/978,238, filed on Oct. 8, 2007.

(51) Int. Cl. G06Q 30/00

(52) U.S. Cl. 705/14; 705/1

(57) ABSTRACT

According to a computer implemented approach for expeditious resource re-allocation in a network, customers specify what items or services to request or offer by adding to the “MyHaves” or “MyWants” selection criteria. According to the method, a customer requests an item or service by adding it to his/her “MyWants” in any of the following three ways: using a single click, searching and then adding, or feeding in user-defined-inputs. Similarly, a customer declares to offer an item or service by adding it to his/her “MyHaves” in any of the three aforementioned ways. The system algorithm of an embodiment “crawls” to find matches between the “MyHaves” of offerers and the “MyWants” of requesters, paying attention to and giving priority to the proximity and social network rules in the system. When a match is found, the system automatically triggers an email that is sent to the offerer, notifying him/her that a fellow customer wants what the offerer-customer has. If the offerer-customer agrees to deliver the item or service to the requester, the implementation proceeds to require the requester customer to confirm receipt once the item is received. Confirmation of receipt by a requester causes the system to award points or credits to the offerer as a form of reward. These points can then be used—by the awarded offerer—to enjoy discounted purchases at selected system partner businesses. The point system may be implemented adopting a variety of methodologies. In an embodiment of the present invention, customers (users) communicate with one another using the system's “messenger tool” called “TtMessage”, and control the re-allocation of resources by forming their own circles using the “TtCircle” capability therein.

This present invention claims—in a non-provisional context—the benefits and domestic priority of a prior provisional application (Application No. 60/978,238) that relates to resource re-allocation and, more specifically, to a method for automatically matching valuables among a network of seekers and providers on a website.

### FIELD OF THE INVENTION

### Background of the Invention

Conventional resource re-allocation models on the internet exist as “pure marketplaces” where goods and services are exchanged based on monetary value and availability of the items and services. These marketplaces suffer from a number of inefficiencies.

Firstly, the monetary nature therein poses as an obstacle to persons who need the items/services the most but who do not necessarily have the financial wherewithal; many times, the most financially capable person who purchases valuables—or who wins an auction—is not necessarily the person who needs it the most. Furthermore, current approaches that adopt an auction model marketplace have been known to castigate and sometimes expel goods-providers who voluntarily, but with generous intentions, disregard highest bidders and instead offer items to those who need them (the items) the most. Secondly, the said marketplace model has a limitation associated with rampant lack of buyer-seller trust or familiarity, within the marketplace, arising from the large and often sporadic presence of seekers and providers/offerers. An example to illustrate this limitation is a trading website. Very often, the seller ready to offer a good or service has little or no knowledge of the buyer; the buyer also has little or no knowledge of the seller. This, in extreme cases, causes a transaction to be stalled because of a natural feeling of doubt and skepticism via the internet brought on by both parties' complete lack of knowledge of each other. Thirdly, just as in the case of unfamiliarity, there is often an issue of vast geographic distance between the seekers and offerers, thereby causing transportation inconveniences and environmentally unfriendly consequences whenever parties have to pick up or deliver goods and services. The fourth limitation associated with conventional resource allocation websites relates to the sheer size of the marketplace and a purely mechanical search tool that currently fails to take a human-approach to querying methods. Even after using the search/query functions on these conventional platforms, the items and services available—in form of search results—are often so numerous and imprecise that seekers must search through an unwieldy clutter of items while simply looking for one item; often, this means having to scroll along very long pages, and having to browse laboriously through sometimes hundreds or thousands of website pages containing millions of items, merely in the bid to find the one satisfactory item—an ultimate aim that can be otherwise achieved about fifty times more efficiently using the present invention to be discussed.

Given the natural unending demand for goods and services in our societies, and the limitations of the prior methods, there is a pressing need for a more effectual method for resource re-allocation that holistically incorporates all of the following: (i) intelligent social search algorithms that automatically notify seekers of the availability of their “wants”; (ii) proximity convenience in the network; (iii) familiarity and trust enhancing approaches with incentives; (iv) full decision making rights of offerer-members to freely decide whom to give an item regardless of who may have the greatest buying power.

There is yet a further need for an approach for resource re-allocation in communication networks that is more flexible than conventional and prior methods—an approach that allows customers combine the emotional benefits of social networks with the tangible gains derived from electronic commerce.

### SUMMARY OF THE INVENTION

An embodiment of the present invention provides an environmentally conscientious method for conveniently offering/giving or seeking/taking items or services via a system that rewards “offering-customers” (or offerer customers) with points which can be tendered as real money at partner businesses. The present invention combines the emotional benefits of social networks with the concrete gains derived from traditional electronic commerce solutions. The system obviates the hassles, typically faced by customers, of actually doing the search for who wants the item/service, or who is parting with or ready to offer the item/service.

The system uniquely identifies the customer using the profile information supplied by the customer. The customer, by inputting the requisite information, tells the database the goods or services s/he has or wants, and this data is uniquely stored for each customer in the network. This way, the customer—at once, or weekly, or as desired—creates his/her lists of HAVES and WANTS. The system database is in a perpetual search-and-match mode so that when any of the HAVES of one user is found to match any of the WANTS of another user, a notification is triggered to item owners alerting them of a potential opportunity for reallocation of valuables. This reallocation is an outcome of the system's optimization of both the precise desired match (of customer-defined-input) and the convenience of unique social network proximity of the users/customers. The notification occurs via email and upon receiving a notification email in his/her “inbox”, a customer may decide to honor another's request for a good or service—with or without consideration for monetary exchange. When a customer delivers an item to another, the requester (receiving customer) provides the system with a proof of receipt by clicking a button on the implemented website. To compensate and encourage the giver or offerer for such act of kindness, s/he is awarded points which can be used to redeem discounts at selected partner businesses, businesses with a mission to foster re-allocation or to (“go green”) espouse sustainability e.g. airlines, grocery stores, etcetera.

### BRIEF DESCRIPTION OF THE DRAWINGS

Embodiments of the present invention are illustrated and represented by way of hypothetical examples, and not by limitation, in the accompanying illustrations and in which like numerical and alphabetical references refer to like elements, and in which:

FIG. 1 is a diagram depicting the base case interaction in the communications system of an embodiment of the present invention.

FIG. 2 is a diagram showing the two categories or types of customers (potential system users) in an embodiment of the present invention.

FIG. 3 is a diagram exemplifying real life social connections (RLSC) and network social connections (NSC) in an embodiment of the present invention.

FIG. 4 is a diagram illustrating an instance of typical request and offer in an embodiment of the present invention.

FIG. 5 is a flow chart depicting an approach for requesting an item or service in an embodiment of the present invention.

### DETAILED DESCRIPTION OF THE INVENTION

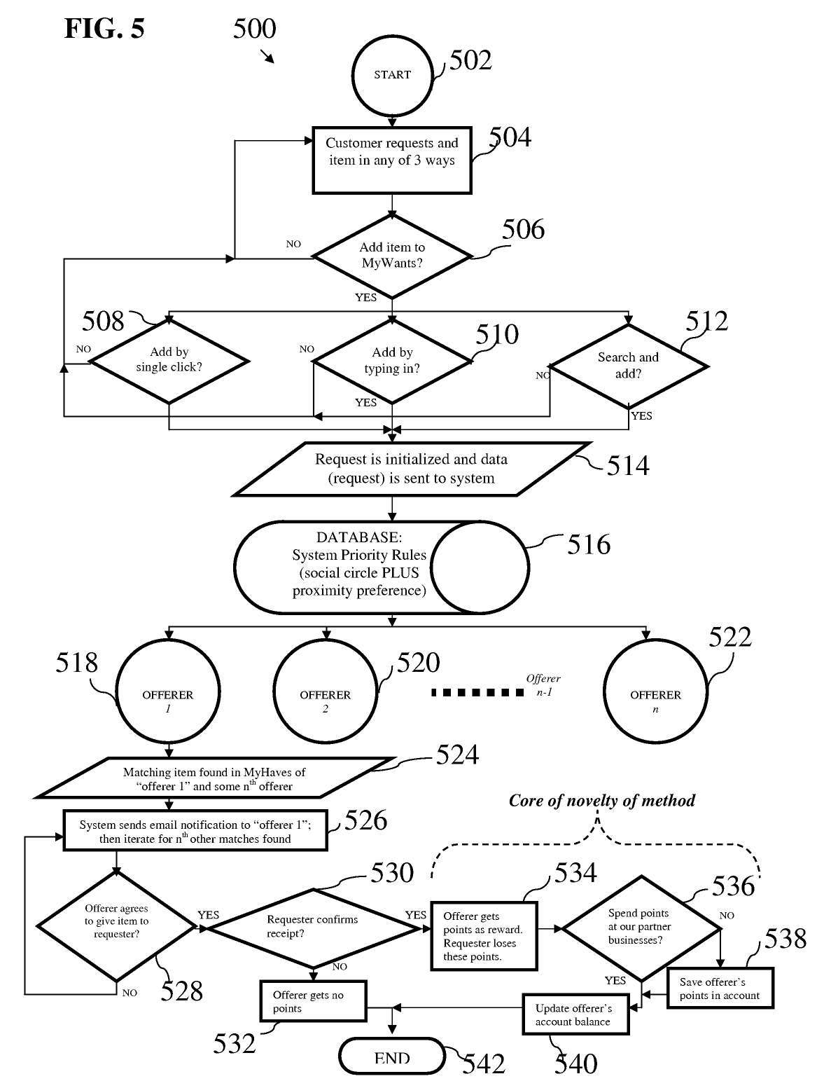

Detailed description herein of the present invention is expressed in stepwise fashion describing the invention holistically. However, the discussion around FIG. 5 occurs at the end of the description and is treated in especially devoted sections, hereinafter, that conclude the description of the invention. These two sections are: (1) the “Search-Match-Notify” algorithm; and (2) the “Partnership Green Points Virtual Currency”.

The present invention provides a method for expeditiously re-allocating resources in a network of members, and a system for doing this in a uniquely environmentally friendly way with the support of a network of business partnerships. As used herein, the terms “resource(s)”, “item(s)”, “good(s)” and “service(s)” are all used interchangeably for the sake of clarity. They refer to anything a customer wishes to part with, dispose of, provide, sell, own, request, or purchase. Examples of these are new or used textbooks, clothing of any kind, electronic devices, music or video stored on non-volatile memory such as tape, optical medium, magnetic medium, etcetera. More interesting examples include services such as tutorials, plumbing, repairs, catering, event planning, and the like. In essence, anything the customer so desires to offer or request, and that can be typed into the system will qualify for a resource, item, good, or service. The customer is not limited in any way at all because the decision of what to request or offer is totally left to the customer's willingness to supply such information to the system.

It the following description, the term “user” refers to the person actively using the system while the term “customer” refers to the person who may or may not be currently using the system. Hence, all users are customers but not all customers are users; better yet, a user is an active instance of “customer” status while a customer could be an active or idle instance of “customer” status.

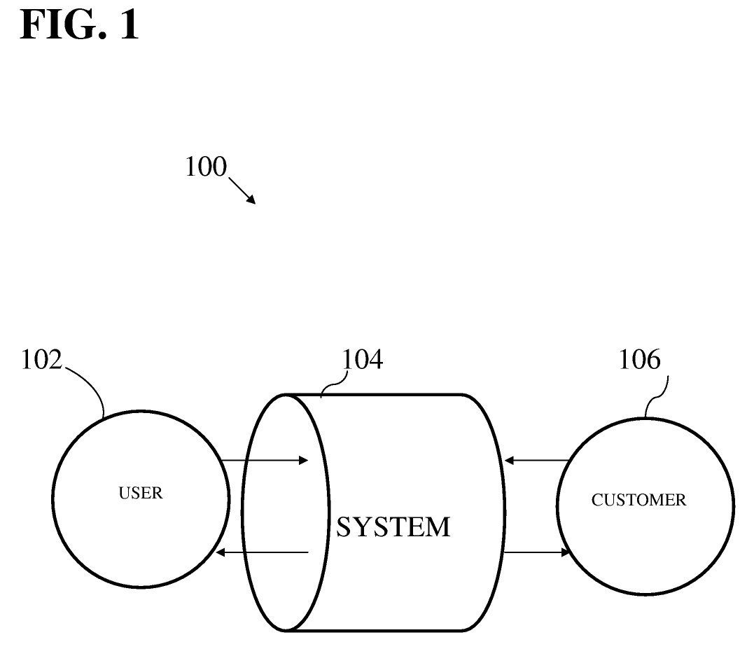

FIG. 1 is a diagram 100 depicting the base case interaction in the communications system of an embodiment of the present invention. It exemplifies a use-case or scenario that serves as a snapshot of a single re-allocation process in the network. User 102 is either requesting or offering a good or service by using the graphical user interface to interact via system 104 which represents the hub of all data storage and processing. Customer 106 represents a customer, part of whose supplied information is a potential match with that of user 102.

In representation 100, if user 102 is requesting an item, user 102 is called a “requester” and such a request could occur in three unique ways. Firstly, it could occur by user 102 manually typing into system 104 what s/he wants; this is called a “user-defined-input”. Secondly, it could be by user 102 searching for the item, and then having found the item, adding it to “MyWants”—a list of things s/he is requesting. The system maintains a combination of internal and external databases of items so that if the use finds an item, s/he can simply click a button to add the item without manually typing many details. Thirdly, if user 102 directly or indirectly discovers that customer 106 has what user 102 is looking for, then user 102 can make a direct request from customer 106 via system 104. In this case where user 102 is a “requester”, customer 106 is referred to as an “offerer” once a match is made, and a match is said to occur when an item in the “MyWants” of user 102 is found to also exist in the “MyHaves”—a list of things s/he is wishing to offer—of customer 106. In like manner, if user 102 is offering an item, user 102 is called an “offerer” and such an offer could occur in three unique ways too. Firstly, it could occur by user 102 manually typing into system 104 what s/he is willing to offer or provide (with or without a picture or image of the item); this, too, is called a “user-defined-input”. Secondly, it could be by user 102 searching for the item (within the database in system 104 and its connected environs), and then having found the item, adding it to “MyHaves”—a list of things s/he is willing to offer. The system maintains a combination of internal and external databases of items so that if the use finds an item, s/he can simply click a button to add the item without manually typing many details. Thirdly, if user 102 directly or indirectly discovers that customer 106 is requesting what user 102 has, then user 102 can kindly initiate a match by indicating a willingness to make an offer to customer 106 via system 104. In this case where user 102 is an “offerer”, customer 106 is expectedly referred to as a “requester” and a match is bound to occur because an item in the “MyHaves” of user 102 was found by the same user 102 to also exist in the “MyWants”—a list of things s/he is wishing to offer—of customer 106.

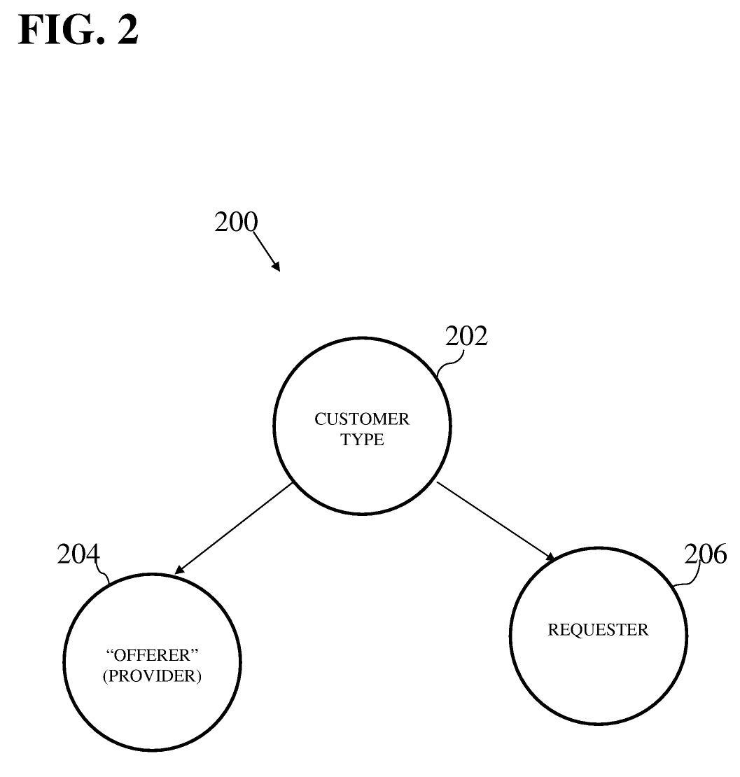

The two scenarios above, one defining a requesting user and the other defining an offerer (or offering) user, are depicted in FIG. 2, a diagram 200 showing the two categories or types of customers (potential system users) in an embodiment of the present invention. As shown and as explained above, a customer in the network can actively exist either as an offerer 204 or requester 206, or both. In a typical embodiment of the present invention, every user is potentially both a requester and an offerer at the same time.

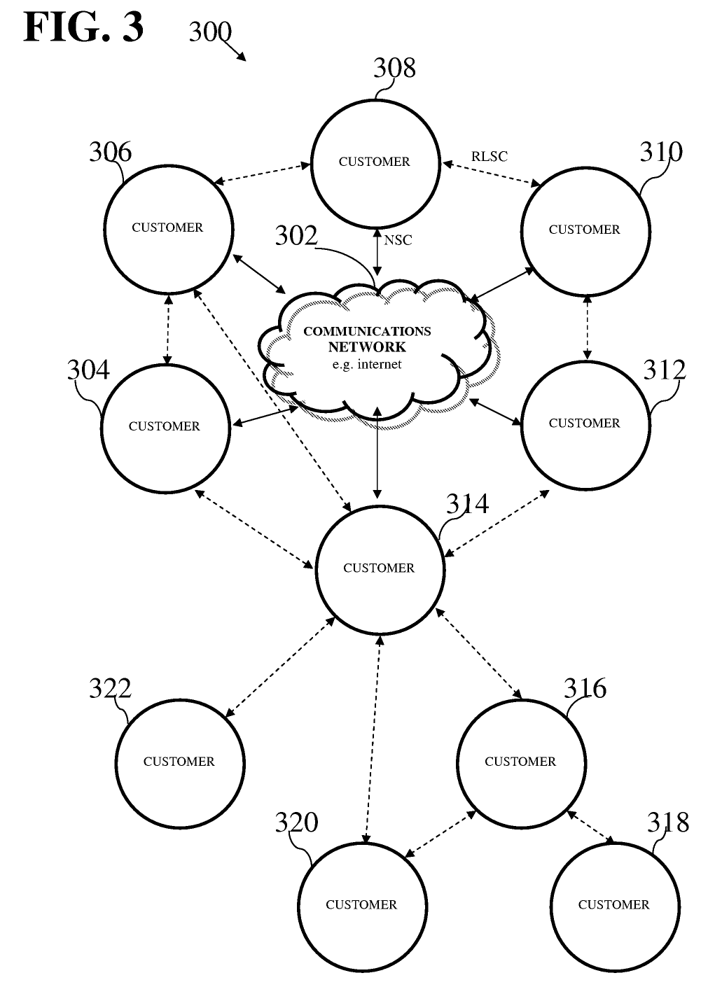

Features of the present invention allow customers in an embodiment to enjoy combined social benefits of social networking and concrete gains from electronic commerce. The core of these features is called the “TtCircle”, simply called “circle”. A “circle” 302 is defined as a group of members that have voluntarily joined a sub-network within the larger system network. There are numerous reasons why customers may wish to be members of such a circle. Some of these reasons include, but are not limited to, the ability to use the system 104 tools to maintain the exclusivity of the circle, to restrict the flow of items and services to just the members of the circle, to create a network for forum discussion or some other social cause, etcetera. FIG. 3 is a diagram 300 exemplifying real life social connections (RLSC) and network social connections (NSC) in an embodiment of the present invention. The dotted arrow connections represent real life social connections while the unbroken arrow connections represent network social connections. A RLSC simply refers to any real life relationship between customers. An NSC refers to the sort of connection between customers in the same “circle” within the larger system network; that is to say, two customers who are connected by an NSC may never have met in real life. A usefulness of the present invention is to convert NSCs to RLSCs, an almost stark reverse to conventional and prior models.

In diagram 300, the number of real life social connections is greater than the number of network social connections, but as said, part of the usefulness of the present invention is to translate or convert network social connections to meaningful real life social connections while still maintaining the former, and this is achieved when a match is made online and a delivery is executed in real-life—perhaps in the neighborhood or on a campus college. Consider a hypothetical case where an “offerer customer” within a circle chooses to deliver an item or service to a “requesting customer” outside the circle but within the larger network of system members; in diagram 300, both customer 304 and customer 322 belong to the larger system network, but while customer 304 belongs to circle 302 (along with customers 306, 308, 310, 312, and 314), customer 322 does not. However, if customer 304, while accessing the profile page of customer 322, sees that an item in the “MyWants” of customer 322 happens to be an item customer 304 is parting with, customer 304 can add the item to his/her (customer 304's) “MyHaves”, and a real life social connection is established when customer 304 actually delivers the item to customer 322; they meet face to face. (The explanations delineating the procedures and dynamics underlying notifications, deliveries, and receipts are detailed in later parts herein—FIG. 5).

Note that in the same diagram 300, while customers [304, 306, 308, 310, 312, and 314], members the same “circle”, can access one another's network profiles and those of others in the system who do not belong to any “circles”, customers 316, 318, 320 and 322 can only access one another's network profiles but not those of the earlier group who exist in a “circle”. An embodiment of the present invention—along with its environmentally conscious algorithms—sees that HAVES and WANTS are matched only if the concerned parties belong to the same “circle”, such as a college circle or any similarly defined circle. As an example, if customer 312 has an item wanted by customer 306, an automatic email will be triggered to customer 312 and s/he can decide to or not to deliver the item to customer 306; because they are both in the same “circle”, the system will trigger an email notification. On the contrary, if customer 318 wants an item that customer 306 is willing to dispose of but which has been designated (by customer 306) to the circle 302, there will neither be a match made nor an email notification sent because it is assumed that customer 306 who belongs to circle 302 has chosen to provide access to his/her item information exclusively to those in his/her circle, barring outsiders such as 318 from such item information within the circle.

According to the ideal best practice embodiment, network social connections are vicarious (for example, customer 304 is connected to customer 308 via the NSC through 302) but real life social networks may not (for example, customer 318 is not connected to customer 322).

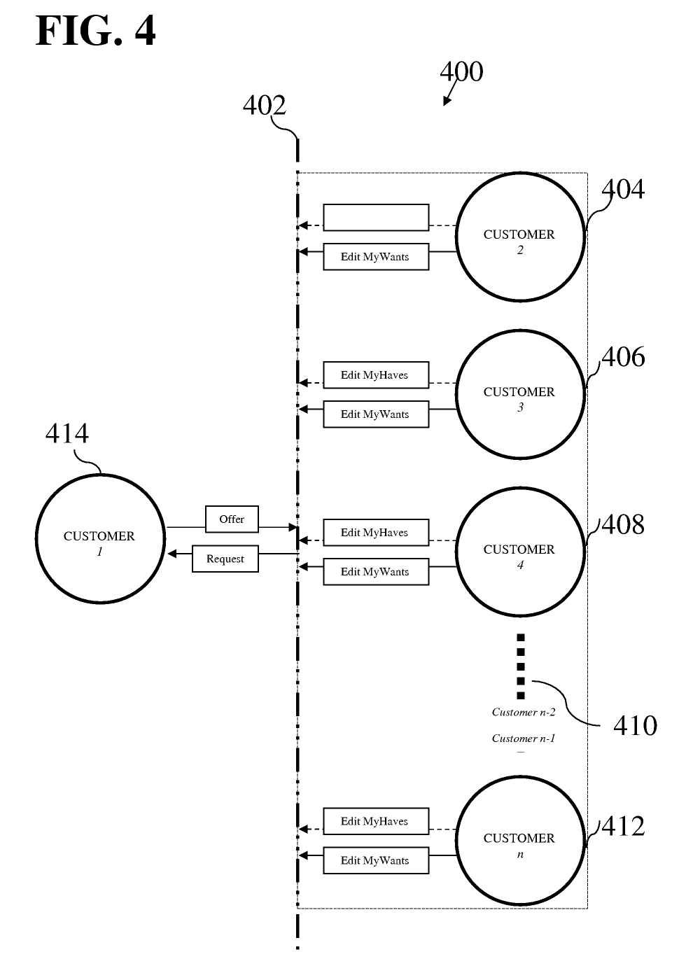

FIG. 4 is a diagram 400 illustrating an instance of typical request and offer in an embodiment of the present invention. Let us consider a request scenario where customer 414 wants an item or service. Interface 402 represents the medium separating customer 414—who is at this point actually using the system and is the one under consideration—from the other customers. As such, customer 414 is referred to as the user while the others, the customers. When user 414 wants an item, the item can be requested in three ways just as explained previously. Firstly, user 414 can choose to browse—as is conventionally done—for the item. Assuming s/he finds that the wanted item is owned by customer 404, user 414 can simply click on a REQUEST button to send alert customer 404 that an item in his/her (customer 404) “MyHaves” has been requested. A second way of requesting is for user 414 to feed into the system 104—using interface 402—the description of the sought item. This “user-defined-input” will be fed in by means of a keyboard or some other convenient data input devise at the convenience of user 414. This item being sought is grouped into the “MyWants” of user 414 and the system actively seeks a match in the “MyHaves” of customers 404, 406, 408 . . . up to 412. If an item or service match is found in the “MyHaves” of any of the latter customers, an email notification will be triggered. Thirdly, user 414 can use the search function in system 104 to search for the item within the system database. If the desired item or service is found during the search, user 414 simply clicks the “Add to MyWants” button in order to request the item. All these are ways by which users can request items. The process is the same for offering items except that instead of grouping the item into user 414's “MyWants”, the item is grouped in his/her (user 414's) “MyHaves”. Peradventure there are multiple customers ready to offer an item or service requested by one customer, the requesting customer is free to decide from whom s/he wishes to take the item. In such case, system 104 invokes special algorithms that prioritize the customers in question, and this step could be implemented in various ways that conform to best practice.

### 1. The “Search-Match-Notify” Algorithm.

FIG. 5 is a flow chart depicting an approach for requesting an item or service in an embodiment of the present invention. One skilled in the art would appreciate that the following algorithmic elements could be rearranged or adapted in various ways.

The “Search-Match-Notify” algorithm is the key to efficiency in an embodiment of the present invention. The flow chart 500 in FIG. 5 typifies an embodiment's entire process flow, exemplifying a use-case in which a customer request 504 kick-starts the algorithm in step 502. The customer can request an item by adding it to his/her “MyWants” 506, else the system loops back to 504 waiting to initialize 502. The customer does this (adding it to his/her “MyWants” 506) in any of three ways which include adding by using a single click 508, or adding by typing in 510, or adding by searching first and then adding once found 512. In step 508, if the customer adds by clicking, the customer is taken to step 514, else the system loops back to step 506. In step 510, if the customer adds by typing in, the customer is taken to step 514, else the system loops back to step 506. As is expected, in step 512, if the customer adds by searching first before adding, the customer is taken to step 514, else the system loops back to step 506. The data or request in step 514 is saved directly in the system database 516 at which point the system's priority rules are invoked. Embodiments of the present invention can implement the priority rules in step 516 in various ways to maximize efficiency for the desired purpose. One of such purposes—which is of primary importance to the invention of this method—is an environmental purpose. That is to say, in step 516, the desired and ideal embodiment can implement priority rules where matches to be made, between HAVES and WANTS, are done such that customers who are in close proximity to one another are given a higher match priority so that the delivery or pick-up of an item or service in real life will require the least need for driving (pollution) since such algorithm seeks to pair those customers whose geographic proximity is rather a stone-throw away from one another. Further, such an algorithm grants higher match priority to customers who have a real life social connection between them.

The data in step 516 is analyzed comparatively with the “MyHaves” information corresponding to customers 518, 520 . . . 522. In step 524, if the algorithm finds that customer 518 or any other customer has the item or service being requested by the requesting customer, then in step 526 the system will send an email notification to the matched offerer-customers based on the order set by the priority rules in step 516. In step 528, the offerer can choose to honor the requester's request. If honored, the requester is sent an email by the system asking the requester for confirmation of item/service receipt at the time of receipt of the item or service in step 530. Note that in step 528, if the offerer does not indicate an agreement to deliver the item, then the system loops back to step 526 but the same email (that was last triggered by 526) will not be resent. It is assumed, at this point and in such a scenario, that the said offerer does not wish to give the requester that item or service. In step 530, after the requester meets with the offerer at an agreed upon venue, and after the item or service has actually been delivered to the requester, the requester confirms receipt. The requester's confirmation of receipt allows the system to verify an item delivery by the offerer. For such act of kindness, the offerer is rewarded with points—a virtual currency in an embodiment—in step 534. Otherwise, the offerer did not deliver the item and hence gets no points in step 532. Notice that in step 534, the points the offerer gets as reward are deducted from the account balance of the requester customer who received the item. The idea behind giving points to offerers is that such reward encourages the offerer to continue disposing of his/her resources more responsible ways using the embodiment.

### (2) The “Partnership Green Points Virtual Currency”.

The point system is one of special value and interest. The system is such that the number of points attached to each item or service is called the item's valuation, and the valuation of an item or service is determined by an algorithm that combines (i) the weighted social votes or suggestions of what customers in the system think an item's valuation should be, and (ii) the number of times the item occurs in the aggregate HAVES (total supply) compared to the number of times it occurs in the aggregate WANTS (total demand) on the system. This implies that items that occur ubiquitously in the “MyHaves” of customers but so scarcely in the “MyWants” of customers across the platform will have low valuations since the aforementioned implies “high supply and low demand”, hence fewer points will be associated with such an item or service. This, together with the social votes, is the basis of the algorithmic scale used to determine points in the system. One skilled in the art will quickly see that the point system can be implemented in various ways which include, but are not limited to, credits, discounted subscriptions, free storage space to members, etcetera. An embodiment of the present invention will seek to see that such a virtual currency algorithm intentionally strives to deviate from the conventional web marketplace or real life marketplace. The aim is to dislocate the virtual world from the real world so as to create a paradigm shift where the customers influence the valuation system by virtue of social influence rather than by financial prowess as is the case in real life.

Once awarded the points as a token to compensate for his/her generosity, the offerer customer in step 536 can spend his/her earned points in form of discounts or real cash at businesses that have partnered with the system for a strategic purpose; these businesses are system partners that agree to accept the points earned as a legal tender of some sort. Examples of these business partners include airline companies, grocery stores, restaurants, electronics stores, and a host of others that cannot be enumerated. Examples of feasible strategic purposes include revenue share benefits, customer acquisition benefits, and ideal environment improvement consequences. In step 536, the offerer customer may choose to save his/her points/rewards towards a later date in step 538.

The invention claimed, as per a prior provisional application with the same title, is:

1. A computer-implemented method for expeditiously re-allocating resources to—and amongst—customers, the method comprising:
providing an efficient way for customers to request and obtain an item or service without requiring them to spend time searching or browsing through pages;
thereby automatically informing a specific requester as soon as a member-customer has what the former is seeking and automatically informing a specific offerer as soon as a member-customer wants what the former is offering;
combining elements of social networks and electronic commerce so as to enhance customers' decision making power by providing a platform where the ability of customers to obtain an item or service is determined by customers' social influence rather than by customers' purchasing power; and
obviating the need to commute long distances to deliver or pick up an item since re-allocation is algorithmically implemented by paying scrupulous attention to the geographic proximity of customers
whereby offerers who actually give requesters an item or service are awarded points that serve as a legal tender at specified partner businesses.

2. A method as recited in claim 1, wherein the requesting or offering of an item is a simple one-click process once the customer sees the item.

3. A method as recited in claim 1, wherein the requesting or offering of an item is a simple search-and-add process if the customer so wishes to add an item without typing many details.

4. A method as recited in claim 1, wherein the requesting or offering of an item is a user-defined-input comprising the customer's desired language of input using keyboard characters or any input device thereof.

5. A method as recited in claim 1, wherein the “MyHaves” that are geographically and socially closest to specified “MyWants”, and vice-versa, are given priority over geographically or socially distant customers.

6. A socio-commerce method as recited in claim 1, wherein the eco-system of “Partnership Green Points Virtual Currency” is modeled to espouse environmental sustainability.

7. A computer implemented method as recited in claim 1, wherein the system—and not the customers—does the work by implementing an autonomous “search-match-notify” algorithm.

8. A method as recited in claim 7, wherein simply by disposing of owned unneeded items in responsible ways, customers can earn points which serve as a legal tender elsewhere outside the system (e.g. offline, in real life at partner businesses: stores, airlines etc).

9. A method as recited in claim 8, wherein rather than transforming real life relationships to virtual ones, virtual relationships are transformed to meaningful real life relationships via the face-to-face nature of delivering or picking up an item or service.

10. An on-line system on the World Wide Web (“WWW”) that rather than replicates a real life marketplace, deviates from it by allowing the combination of customer votes and comparisons of “MyHaves” with “MyWants” to determine the point-valuation of an item, causing the valuation of an item in the system to have almost no resemblance to its price in real life.
